(19) United States
(12) Patent Application Publication
(10) Pub. No.: US 2012/0084728 A1
(43) Pub. Date: Apr. 5, 2012

(54) BUTTON CONTROL SYSTEM FOR MEDICAL TOUCH SCREEN AND METHOD THEREOF

(76) Inventors: Wen-Liang HUANG, Hsinchu (TW); Hung-Pin Chen, Hsinchu (TW); Chao-Ming Chiu, Hsinchu (TW); Tsan-Chung Lee, Hsinchu (TW); Jui-Hung Tai, Hsinchu (TW)

(21) Appl. No.: 12/897,876

(22) Filed: Oct. 5, 2010

(51) Int. Cl. G06F 3/048; G06F 3/041

(52) U.S. Cl. 715/810; 345/173

(57) ABSTRACT

A button control system for medical touch screen and method thereof comprises a central control module, a touch signal input module, a lock time control module, a button lock module, a button unlock module and a cleanse display module, wherein the central control module determines the signal inputted by the touch signal input module, and selects to control the button lock module or the button unlock module thereby locking or unlocking a touch button; furthermore, the lock time control module is configured to set up the lock time for the touch button so as to preset the lock time of the touch button as cleansing the touch screen by the user, and after pressing down the cleanse touch button on the touch screen, it allows to control to lock or unlock other touch buttons and also to effectively prevent the occurrence of the situation where the screen button is erroneously touched as performing the cleanse process.

### BACKGROUND OF THE INVENTION

1. Field of the Invention

The present invention relates to a button control system for medical touch screen and method thereof; in particular, the present invention relates to a button control system for medical touch screen which can lock the touch screen such that the button on the touch screen becomes inoperable thereby preventing that the button on the touch screen would be erroneously touched as a user performing the cleanse process.

2. Description of Related Art

Touch screens have been long-time comprehensively applied to a variety of computer equipments such as industrial control computer, POS peer computer handheld Personal Digital Assistant (PDA), gaming console, embedded system and the like. These applications are essentially characterized in that the environment where such applications are deployed may not be in majority available for input operations by means of keyboard or mouse, or even that the touch screen itself suffices to handle most of the operations along with merely certain simple button operations, and in case advanced manipulations or fine tunings are needed, it is then possible to further conjunctively employ the keyboard/mouse to complete the task. At present, conventional touch screens have been already widely employed in various fields, ranging from mobile phone, PDA, Automatic Teller Machine (ATM) to industrial purpose touch screen computers, all of which provide the touch screen interface required for achieving vivid human-machine interface presentations.

In accordance with operative principles of sensor and signal transmission methods, the conventional touch screen can be roughly categorized into capacitance based, resistance based, infrared light (IR) based and sound wave based screens, and the biggest difference thereof from the conventional screen lies in that the touch screen may act as a type of bi-directional controller enabling screen outputs as well as instruction inputs, directly making selections on the screen by using a finger in order to perform required operations thereby replacing traditional mechanical button panels and creating attractive audio-video effects through screen displays.

However, as performing a cleanse process on the touch screen, it is very likely to erroneously contact or press down other touch buttons and activate unnecessary operations. For example, as applying the touch screen to the operative room, should blood or some other liquids be accidentally splashed onto the touch screen, it is absolutely required to clean it up immediately so as to prevent potential mistakes during surgical treatment. But, for currently available touch screens, if a real-time cleanse process needs to be performed, other touch buttons thereon would be inevitably touched, and suppose another screen page are thus mistakenly opened, for example, some critical physical information on the patient may be missed, or otherwise even more serious errors in surgical operations may accordingly occur. Regarding to such problems, it can be clearly seen that currently available touch screens remain to be desired in their designs, which also signifies an issue to be desirably resolved in the industry.

Hence, it would be an optimal solution if a button control system for medical touch screen and method thereof can be provided which specifically allows to prevent the user from erroneously touching the button on the touch screen as the cleanse process being performed thereon.

### SUMMARY OF THE INVENTION

An objective of the present invention is to provide a button control system for medical touch screen and method thereof which can lock or unlock the touch button on the touch screen thereby preventing erroneously touching the touch button as performing the cleanse process.

Another objective of the present invention is to provide a button control system for medical touch screen and method thereof which can lock or unlock the touch button in real-time thereby facilitating the user to perform the cleanse process efficiently.

A button control system for medical touch screen and method thereof enabling achievement of the aforementioned objectives comprises a central control module, a touch signal input module, a lock time control module, a button lock module, a button unlock module and a cleanse display module, in which the central control module determines the signal inputted by the touch signal input module, and selects to control the button lock module or the button unlock module thereby locking or unlocking a touch button; furthermore, the lock time control module is configured to set up the lock time for the touch button so as to preset the lock time of the touch button as cleansing the touch screen by the user, and after pressing down the cleanse touch button on the touch screen, the cleanse display module, in addition to controlling to lock or unlock other touch buttons, also shows that the touch screen is currently performing cleanse process, thus the locking of touch button can effectively prevent the occurrence of the situation where the screen button is erroneously touched as cleansing the touch screen.

More specifically, the aforementioned central control module can be additionally coupled to a power switch module in which the power switch module may perform the power switch control on the touch screen as the user operating the touch button on the touch screen (power switch touch button).

More specifically, the aforementioned central control module can be additionally coupled to a volume adjustment module in which the volume adjustment module may perform the volume-up control or volume-down control on the touch screen as the user operating the touch button on the touch screen (volume adjustment touch button).

More specifically, the aforementioned central control module can be additionally coupled to a brightness adjustment module in which the brightness adjustment module may perform the brightness-up control or brightness-down control on the touch screen as the user operating the touch button on the touch screen (brightness adjustment touch button).

More specifically, the aforementioned central control module can be additionally coupled to a screen switch module in which the screen switch module may perform the screen switch control on the touch screen as the user operating the touch button on the touch screen (screen switch touch button).

### BRIEF DESCRIPTION OF THE DRAWINGS

FIG. 1 shows a structural diagram of a button control system for medical touch screen and method thereof according to the present invention;

FIG. 2 shows another structural diagram of a button control system for medical touch screen and method thereof according to the present invention;

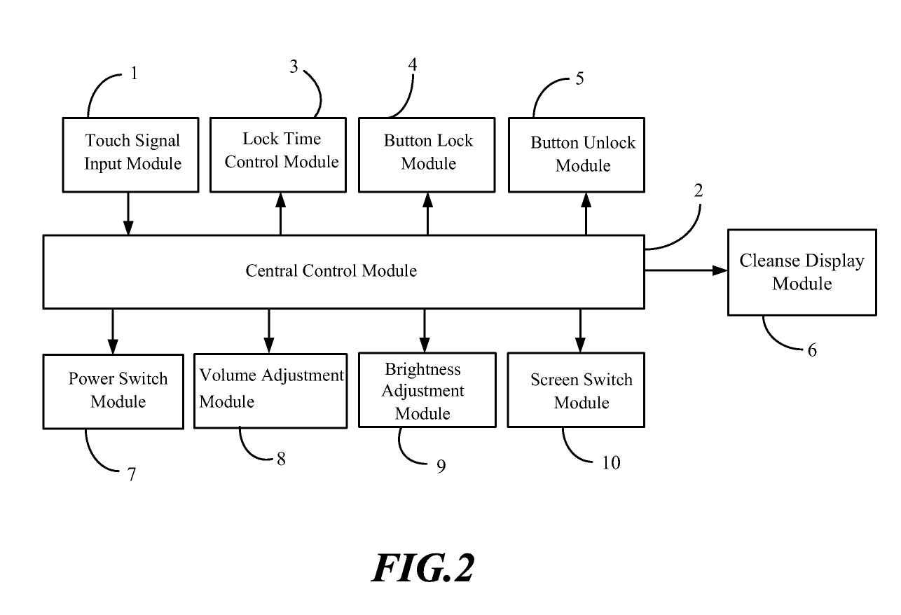

FIG. 3 shows an operational flowchart of a button control system for medical touch screen and method thereof according to the present invention; and

FIG. 4 shows a front screen view of a button control system for medical touch screen and method thereof according to the present invention.

### DETAILED DESCRIPTION OF THE PREFERRED EMBODIMENTS

The aforementioned and miscellaneous technical contents, features and effects of the present invention can be clearly appreciated through illustrating the following detailed descriptions for preferred embodiments of the present invention with reference to the appended diagrams thereof.

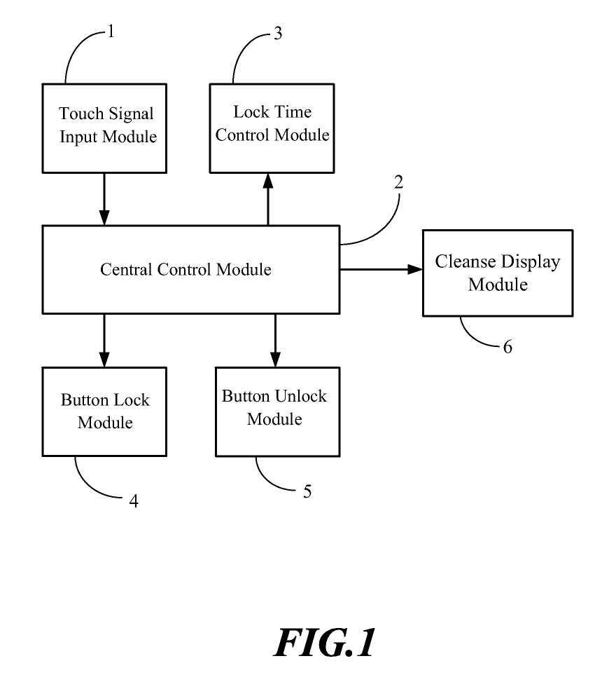

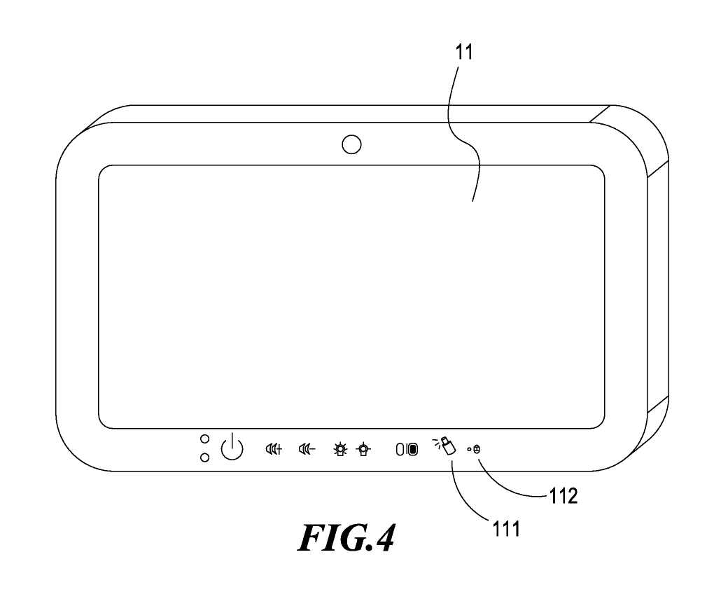

Now refer conjunctively to FIGS. 1 and 4, wherein a structural diagram and a front screen view of a button control system for medical touch screen and method thereof according to the present invention are shown. The button control system for medical touch screen can be used to control touch buttons displayed on a touch screen 11, and a user is allowed to press down the cleanse touch button 111 on the touch screen 11 to perform a cleanse process. It can be seen from these Figures that the button control system for medical touch screen comprises:

a touch signal input module 1, which inputs the signal generated by pressing down the cleanse touch button 111 on the touch screen 11 to the button control system for medical touch screen;

a central control module 2, which is interfaced with the touch signal input module 1, said central control module 2 determining the signal inputted by the touch signal input module 1 and selecting to lock or unlock the touch button;

a lock time control module 3, which is interfaced with the central control module 2 for setting the lock time of the touch button thereby allowing to preset the lock time of the touch button as the user cleansing the touch screen 11;

a button lock module 4, which is interfaced with the central control module 2 wherein the button lock module 4 locks the touch button when the central control module 2 determines locking of the touch button;

a button unlock module 5, which is interfaced with the central control module 2 wherein the button unlock module 5 unlocks the locked touch button when the central control module 2 determines unlocking of the touch button;

a cleanse display module 6, which is interfaced with the central control module 2 and used to drive the cleanse light 112 on the touch screen 11 in order to indicate that the touch screen 11 is performing a cleanse process when the user presses down the cleanse touch button 111 on the touch screen 11.

It should be noticed that the central control module 2 can be additionally coupled to a power switch module 7 in which the central control module 2 controls the power switch module 7 to perform the power switch control of the touch screen 11 when the user operates the touch button (power switch touch button) on the touch screen 11.

It should be noticed that the central control module 2 can be additionally coupled to a volume adjustment module 8 in which the central control module 2 controls the volume adjustment module 8 to perform the volume-up control or volume-down control of the touch screen 11 when the user operates the touch button (volume adjustment touch button) on the touch screen 11.

It should be noticed that the central control module 2 can be additionally coupled to a brightness adjustment module 9 in which the central control module 2 controls the brightness adjustment module 9 to perform the brightness-up control or brightness-down control of the touch screen 11 when the user operates the touch button (brightness adjustment touch button) on the touch screen 11.

It should be noticed that the central control module 2 can be additionally coupled to a screen switch module 10 in which the central control module 2 controls the screen switch module 10 to perform the screen switch control of the touch screen 11 when the user operates the touch button (screen switch touch button) on the touch screen 11.

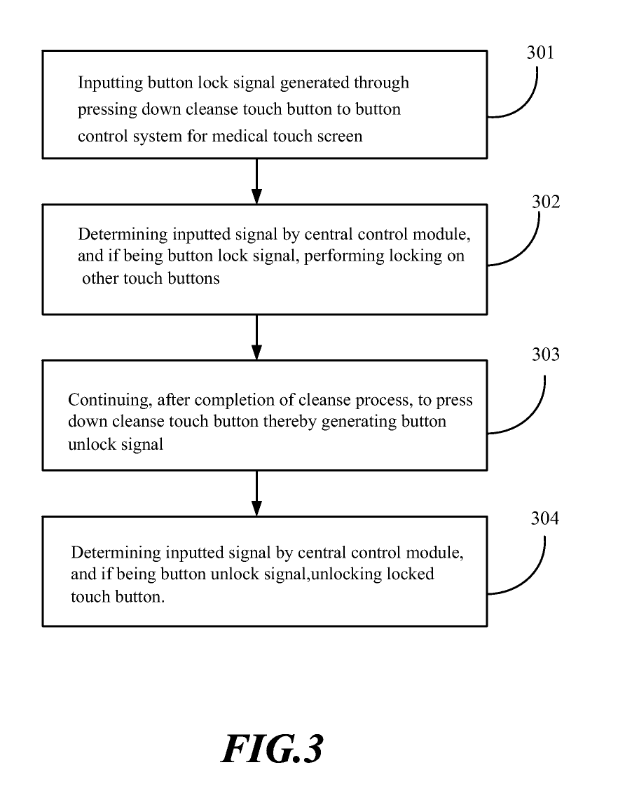

Refer next to FIG. 3, wherein an operational flowchart of a button control system for medical touch screen and method thereof according to the present invention is shown. It can be seen from FIG. 3 that the button control method for medical touch screen comprises:

1. inputting a button lock signal generated through pressing down the cleanse touch button by the touch signal input module to the button control system for medical touch screen as the user pressing down the cleanse touch button on the touch screen (301);

2. determining by the central control module the signal inputted from the touch signal input module, and if the inputted signal is a button lock signal, then controlling the button lock module to perform locking on the other touch buttons (302);

3. after completion of the cleanse process by the user, under the situation of touch button locking, continuing to press down the cleanse touch button (3 s) on the touch screen thereby generating a button unlock signal and inputting the signal to the central control module (303);

4. determining by the central control module the inputted signal from the touch signal input module, and if the inputted signal is a button unlock signal, then controlling the button unlock module to unlock the locked touch button (304).

It should be noticed that the user can preset the lock time of the touch button by means of the lock time control module, and under the situation of touch button locking, when the preset lock time of the touch button ends, it automatically determines whether the user inputs a button lock signal; if yes, then continuing to lock the touch button; otherwise, unlocking the locked touch button.

It should be noticed that in case the inputted signal is a button lock signal, in addition to the cleanse touch button, other touch buttons (e.g., power switch touch button, volume adjustment touch button, brightness adjustment touch button, screen switch touch button etc.) can be locked.

Compared with other conventional technologies, the button control system for medical touch screen and method thereof according to the present invention provides the following advantages:

1. in performing a cleanse process, the present invention allows the user to control the locking or unlocking of the touch screen thereby preventing the situation of mistakenly pressing down the touch button on the touch screen during the cleanse process;

2. through directly pressing down the cleanse touch button on the touch screen, the present invention enables real-time locking or unlocking of the touch button thereby facilitating the user to perform the cleanse process more efficiently.

By means of the aforementioned detailed descriptions of the preferred embodiments according to the present invention, it is intended that the characteristics and features of the present invention can be better illustrated and appreciated, rather than limiting the scope of the present invention by the preferred embodiments disclosed as above. Contrarily, it is desired that all effectively equivalent changes, modifications or substitutions made thereto are encompassed by the scope of the present invention as delineated in the claims set forth hereunder.

What is claimed is:

1. A button control system for medical touch screen used to control touch buttons on a touch screen and a user can perform a cleanse process by means of pressing down the cleanse touch button on the touch screen wherein the button control system for medical touch screen comprises:
a touch signal input module, which inputs the signal generated by pressing down the cleanse touch button on the touch screen to the button control system for medical touch screen;
a central control module, which is interfaced with the touch signal input module, said central control module determining the signal inputted by the touch signal input module and selecting to lock or unlock the touch button;
a lock time control module, which is interfaced with the central control module for setting the lock time of the touch button;
a button lock module, which is interfaced with the central control module wherein the button lock module locks the touch button when the central control module determines locking of the touch button;
a button unlock module, which is interfaced with the central control module wherein the button unlock module unlocks the locked touch button when the central control module determines unlocking of the touch button; and
a cleanse display module, which is interfaced with the central control module and used to indicate that the touch screen is performing a cleanse process.

2. The button control system for medical touch screen according to claim 1, wherein the central control module is further coupled to a power switch module in which the central control module controls the power switch module to perform the power switch control of the touch screen when the user operates the touch button on the touch screen.

3. The button control system for medical touch screen according to claim 1, wherein the central control module is further coupled to a volume adjustment module in which the central control module controls the volume adjustment module to perform the volume-up control or volume-down control of the touch screen when the user operates the touch button on the touch screen.

4. The button control system for medical touch screen according to claim 1, wherein the central control module is further coupled to a brightness adjustment module in which the central control module controls the brightness adjustment module to perform the brightness-up control or brightness-down control of the touch screen when the user operates the touch button on the touch screen.

5. The button control system for medical touch screen according to claim 1, wherein the central control module is further coupled to a screen switch module in which the central control module controls the screen switch module to perform the screen switch control of the touch screen when the user operates the touch button on the touch screen.

6. A button control method for medical touch screen comprises the following steps:
(1) inputting a button lock signal generated through pressing down the cleanse touch button by the touch signal input module to the button control system for medical touch screen as the user pressing down the cleanse touch button on the touch screen;
(2) determining by the central control module the signal inputted from the touch signal input module, and if the inputted signal is a button lock signal, then controlling the button lock module to perform locking on the other touch buttons;
(3) after completion of the cleanse process by the user, under the situation of touch button locking, continuing to press down the cleanse touch button on the touch screen thereby generating a button unlock signal and inputting the signal to the central control module; and
(4) determining by the central control module the inputted signal from the touch signal input module, and if the inputted signal is a button unlock signal, then controlling the button unlock module to unlock the locked touch button.

7. The button control method for medical touch screen according to claim 6, wherein that the user can preset the lock time of the touch button by means of the lock time control module.

8. The button control method for medical touch screen according to claim 7, under the situation of touch button locking, when the preset lock time of the touch button ends, automatically determining whether the user inputs a button lock signal; if yes, then continuing to lock the touch button; otherwise, unlocking the locked touch button.
